(19) United States
(12) Patent Application Publication
(10) Pub. No.: US 2024/0213550 A1
(43) Pub. Date: Jun. 27, 2024

(54) SOLID ELECTROLYTE FILM AND BATTERY EMPLOYING THE SAME

(71) Applicant: INDUSTRIAL TECHNOLOGY RESEARCH INSTITUTE, Hsinchu (TW)

(72) Inventors: Kuan-Yu CHEN, Taichung City (TW); Chia-Chen FANG, Taipei City (TW); Sheng-Hui WU, Hsinchu City (TW); Chun-Lung LI, Taoyuan City (TW)

(73) Assignee: INDUSTRIAL TECHNOLOGY RESEARCH INSTITUTE, Hsinchu (TW)

(21) Appl. No.: 18/519,457

(22) Filed: Nov. 27, 2023

(30) Foreign Application Priority Data
Dec. 27, 2022 (TW) 111150111

(51) Int. Cl. H01M 10/42; H01M 10/0562

(52) U.S. Cl. CPC H01M 10/4235; H01M 10/0562; H01M 2300/008; H01M 2300/0094

(57) ABSTRACT

A solid electrolyte film and a battery employing the same are provided. The solid electrolyte film includes a first protective layer, a second protective layer, and an electrolyte layer, wherein the electrolyte layer is disposed between the first protective layer and the second protective layer. The first protective layer includes a first inorganic material, the second protective layer includes a second inorganic material, and the electrolyte layer includes a third inorganic material. Each of the first inorganic material and the second inorganic material includes an oxide solid electrolyte. The third inorganic material includes a sulfide solid electrolyte.

### CROSS REFERENCE TO RELATED APPLICATIONS

This application claims priority of Taiwan Patent Application No. 111150111, filed on Dec. 27, 2022, the entirety of which is incorporated by reference herein.

### TECHNICAL FIELD

The disclosure relates to a solid electrolyte film and a battery employing the same.

### BACKGROUND

Lithium-ion secondary batteries are mainstream commercial products, which are presently being developed to be lightweight, smaller-volume, safer, and having a higher energy capacity and a longer cycle life. In terms of present conventional liquid electrolyte lithium-ion batteries, the energy storage cost per unit thereof is high due to the low gravimetric energy density and the limited cycle life. However, unilaterally increasing the energy density of batteries can easily induce various safety problems such as liquid leakage, battery swelling, heating, fuming, burning, explosion, and the like in electrochemical batteries and further limit their applicability.

Solid electrolytes with higher safety and the ability to suppress lithium dendrite growth have attracted public attention. However, conventional solid electrolytes, such as ceramic solid electrolytes, face challenges such as high interface impedance, low ionic conductivity, and insufficient mechanical strength. Additionally, while sulfur-based solid electrolytes exhibit higher conductivity, their high reactivity with electrodes leads to self-decomposition and failure, resulting in reduced battery cycle life and poor charging/discharging performance.

Therefore, a novel design for a solid electrolyte for use in lithium-ion batteries is called for solving the aforementioned problems.

### SUMMARY

According to embodiments of the disclosure, the disclosure provides a solid electrolyte film. The solid electrolyte film includes a first protective layer, a second protective layer, and an electrolyte layer, wherein the electrolyte layer is disposed between the first protective layer and the second protective layer. The first protective layer includes a first inorganic material, the second protective layer includes a second inorganic material, and the electrolyte layer includes a third inorganic material. The first inorganic material and the second inorganic material individually includes an oxide solid electrolyte. The third inorganic material includes sulfide solid electrolyte.

According to embodiments of the disclosure, the disclosure also provides a battery. The battery includes a negative electrode, the solid electrolyte film of the disclosure, and a positive electrode, wherein the solid electrolyte film is disposed between the positive electrode and the negative electrode.

### BRIEF DESCRIPTION OF THE DRAWINGS

The present invention can be more fully understood by reading the subsequent detailed description and examples with references made to the accompanying drawings, wherein:

FIG. 1 is a cross-sectional view of the solid electrolyte film according to embodiments of the disclosure.

FIG. 2 is a schematic view of the battery according to embodiments of the disclosure.

FIG. 3 is a graph plotting the voltage of battery disclosed in Example 5 of the disclosure against time (charging/discharging cycle).

FIG. 4 is a graph plotting the voltage of battery disclosed in Comparative Example 4 of the disclosure against time (charging/discharging cycle).

FIG. 5 is a graph plotting the voltage of battery disclosed in Example 6 of the disclosure against time (charging/discharging cycle).

FIG. 6 is a graph plotting the voltage of battery disclosed in Comparative Example 5 of the disclosure against time (charging/discharging cycle).

FIG. 7 is a graph plotting the voltage of battery disclosed in Example 7 of the disclosure against time (charging/discharging cycle).

FIG. 8 is a graph plotting the voltage of battery disclosed in Comparative Example 6 of the disclosure against time (charging/discharging cycle).

FIG. 9 is a graph plotting the voltage of battery disclosed in Example 8 of the disclosure against time (charging/discharging cycle).

### DETAILED DESCRIPTION OF DISCLOSED EMBODIMENTS

The solid electrolyte film and the battery employing the same of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

It should be noted that the elements or devices in the drawings of the disclosure may be present in any form or configuration known to those skilled in the art. In addition, the expression “a layer overlying another layer”, “ a layer is disposed above another layer”, “ a layer is disposed on another layer”, and “ a layer is disposed over another layer” may refer to a layer that directly contacts the other layer, and they may also refer to a layer that does not directly contact the other layer, there being one or more intermediate layers disposed between the layer and the other layer.

The drawings described are only schematic and are non-limiting. In the drawings, the size, shape, or thickness of some of the elements may be exaggerated and not drawn on scale for illustrative purposes. The dimensions and the relative dimensions do not correspond to actual location to practice of the disclosure. The disclosure will be described with respect to particular embodiments and with reference to certain drawings but the disclosure is not limited thereto.

Moreover, the use of ordinal terms such as “first”, “second”, “third”, etc., in the disclosure to modify an element does not by itself connote any priority, precedence, or der of one claim element over another or the temporal order in which it is formed, but are used merely as labels to distinguish one claim element having a certain name from another element having the same name (but for use of the ordinal term) to distinguish the claim elements.

The disclosure provides a solid electrolyte film and a battery employing the same (such as a lithium battery). According to embodiments of the disclosure, the solid electrolyte film includes a first protective layer, a second protective layer, and an electrolyte layer, wherein the electrolyte layer is disposed between the first protective layer and the second protective layer. Due to the specific components of the protective layer of the solid electrolyte film and the electrolyte layer, the flexibility, ionic conductivity, and mechanical strength of the solid electrolyte film are enhanced. In addition, the electrolyte layer of the disclosure (such as an electrolyte layer including sulfide solid electrolyte) is disposed between the first protective layer and the second protective layer, thereby improving the lithium ion transmission, and avoiding the electrolyte layer directly contacting the negative electrode active layer, which deteriorates the performances of battery. As a result, by means of the solid electrolyte film of the disclosure, the stability, charging/discharging performance, and safety of batteries employing the same are improved, thereby extending the cycle life of the battery.

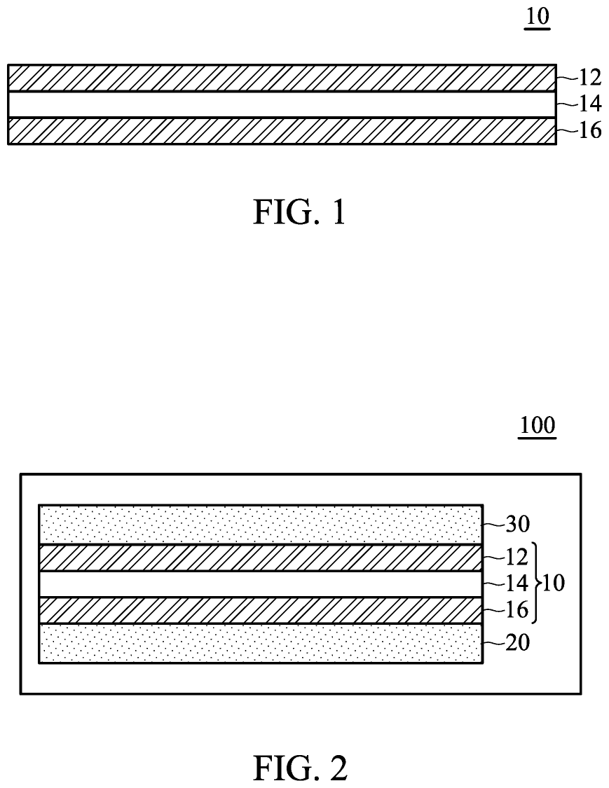

According to embodiments of the disclosure, the solid electrolyte film of the disclosure may be a solid electrolyte film used in lithium battery (such as lithium-ion battery or lithium metal battery). As shown in FIG. 1, the solid electrolyte film 10 may include a first protective layer 12, a second protective layer 16, and an electrolyte layer 14, wherein the electrolyte layer 14 is disposed between the first protective layer 12 and the second protective layer 16. According to embodiments of the disclosure, the electrolyte layer 14 directly contacts the first protective layer 12 and the second protective layer 16. In addition, according to another embodiment of the disclosure, the solid electrolyte film 10 may consist of the first protective layer 12, the electrolyte layer 14 and the second protective layer 16.

According to embodiments of the disclosure, the first protective layer 12 may include a first inorganic material. According to another embodiment of the disclosure, the first protective layer 12 may consist of the first inorganic material. According to another embodiment of the disclosure, the first protective layer 12, apart from the first inorganic material, does not include any other inorganic materials. According to embodiments of the disclosure, the first protective layer 12 may include the first inorganic material and a first fluorine-containing polymer. According to another embodiment of the disclosure, the first protective layer 12 may consist of the first inorganic material and the first fluorine-containing polymer. In addition, according to embodiments of the disclosure, the weight ratio of the first inorganic material to the first fluorine-containing polymer may be from about 0.1:99.9 to 5:95 (such as 0.2:99.8, 0.5:99.5, 0.8:99.2, 1:99, 1.2:98.8, 1.5:98.5, 2:98, 2.5:97.5, 3:97, 3.5:96.5, 4:96, or 4.5:95.5). When the amount of the first fluorine-containing polymer is too high, the resistance of the solid electrolyte film 10 is increased.

According to embodiments of the disclosure, the thickness of the first protective layer 12 may be from about 30 μm to 200 μm (such as 40 μm, 50 μm, 80 μm, 100 μm, 120 μm, 150 μm, or 180 μm). According to embodiments of the disclosure, when the thickness of the first protective layer 12 falls within the aforementioned range, the obtained solid electrolyte film 10 exhibits sufficient mechanical strength and lower resistance.

According to embodiments of the disclosure, the second protective layer 16 may include a second inorganic material. According to another embodiment of the disclosure, the second protective layer 16 may consist of the second inorganic material. According to another embodiment of the disclosure, the second protective layer 16, apart from the second inorganic material, does not include any other inorganic materials. According to embodiments of the disclosure, the second protective layer 16 may include the second inorganic material and a second fluorine-containing polymer. According to another embodiment of the disclosure, the second protective layer 16 may consist of the second inorganic material and the second fluorine-containing polymer. In addition, according to embodiments of the disclosure, the weight ratio of the second inorganic material to the second fluorine-containing polymer may be about from 0.1:99.9 to 5:95 (such as 0.2:99.8, 0.5:99.5, 0.8:99.2, 1:99, 1.2:98.8, 1.5:98.5, 2:98, 2.5:97.5, 3:97, 3.5:96.5, 4:96, or 4.5:95.5). When the amount of the second fluorine-containing polymer is too high, the obtained solid electrolyte film 10 exhibits increased resistance.

According to embodiments of the disclosure, the thickness of the second protective layer 16 may be about 30 μm to 200 μm (such as 40 μm, 50 μm, 80 μm, 100 μm, 120 μm, 150 μm, or 180 μm). According to embodiments of the disclosure, when the thickness of the second protective layer 16 falls within the aforementioned range, the obtained solid electrolyte film 10 exhibits sufficient mechanical strength and lower resistance.

According to embodiments of the disclosure, the electrolyte layer 14 may include a third inorganic material. According to another embodiment of the disclosure, the electrolyte layer 14 may consist of the third inorganic material. According to another embodiment of the disclosure, the electrolyte layer 14, apart from the third inorganic material, does not include any other inorganic materials. According to embodiments of the disclosure, the electrolyte layer 14 may include the third inorganic material and a third fluorine-containing polymer. According to another embodiment of the disclosure, the electrolyte layer 14 may consist of the third inorganic material and the third fluorine-containing polymer. In addition, according to embodiments of the disclosure, the weight ratio of the third inorganic material to the third fluorine-containing polymer may be about 0.1:99.9 to 5:95 (such as 0.2:99.8, 0.5:99.5, 0.8:99.2, 1:99, 1.2:98.8, 1.5:98.5, 2:98, 2.5:97.5, 3:97, 3.5:96.5, 4:96, or 4.5:95.5). When the amount of the third fluorine-containing polymer is too high, the obtained solid electrolyte film 10 exhibits increased resistance.

According to embodiments of the disclosure, the thickness of the electrolyte layer 14 may be about 30 μm to 700 μm (such as 40 μm, 50 μm, 100 μm, 150 μm, 200 μm, 300 μm, 400 μm, 500 μm, 600 μm, or 650 μm). According to embodiments of the disclosure, when the thickness of the electrolyte layer 14 falls within the aforementioned range, the obtained solid electrolyte film 10 exhibits sufficient mechanical strength, lower resistance and better ionic conductivity.

According to embodiments of the disclosure, the thickness of the solid electrolyte film 10 (such as the total thickness of the first protective layer 12, the second protective layer 16, and the electrolyte layer 14) may be about 200 μm to 1,100 μm (such as 250 μm, 300 μm, 400 μm, 500 μm, 600 μm, 700 μm, 800 μm, 900 μm, or 1,000 μm). According to embodiments of the disclosure, when the thickness of the solid electrolyte film 10 falls within the aforementioned range, the solid electrolyte film 10 exhibits sufficient mechanical strength, lower resistance and better ionic conductivity.

According to embodiments of the disclosure, by means of the addition of the fluorine-containing polymer (such as the first fluorine-containing polymer, second fluorine-containing polymer, or third fluorine-containing polymer), the flexibility and processability of the solid electrolyte film can be increased.

According to embodiments of the disclosure, the first inorganic material may include oxide solid electrolyte. In addition, the first inorganic material may further include sulfide solid electrolyte, halide solid electrolyte, or a combination thereof. Herein, the amount of the oxide solid electrolyte may be 65 wt % to 99 wt % (such as 70 wt %, 75 wt %, 80 wt %, 85 wt %, 90 wt %, or 95 wt %); and, the amount of the components of the first inorganic material non-oxide solid electrolyte (such as sulfide solid electrolyte, halide solid electrolyte or a combination thereof) may be 1 wt % to 35 wt % (such as 2 wt %, 3 wt %, 5 wt %, 10 wt %, 15 wt %, 20 wt %, 25 wt %, or 30 wt %), based on the total weight of the first inorganic material. According to embodiments of the disclosure, in the first inorganic material, the weight ratio of the oxide solid electrolyte to the non-oxide solid electrolyte may be 65:35 to 99:1.

According to another embodiment of the disclosure, the first inorganic material may consist of the oxide solid electrolyte. According to another embodiment of the disclosure, the first inorganic material may consist of the oxide solid electrolyte and sulfide solid electrolyte. According to another embodiment of the disclosure, the first inorganic material may consist of the oxide solid electrolyte and halide solid electrolyte. According to another embodiment of the disclosure, the first inorganic material may consist of the oxide solid electrolyte, halide solid electrolyte and sulfide solid electrolyte.

According to embodiments of the disclosure, the second inorganic material may include oxide solid electrolyte. In addition, the second inorganic material may further include sulfide solid electrolyte, halide solid electrolyte or a combination thereof. Herein, the amount of the oxide solid electrolyte may be 65 wt % to 99 wt % (such as 70 wt %, 75 wt %, 80 wt %, 85 wt %, 90 wt %, or 95 wt %); and, the amount of the components of the second inorganic material non-oxide solid electrolyte (such as sulfide solid electrolyte, halide solid electrolyte or a combination thereof) may be 1 wt % to 35 wt % (such as 2 wt %, 3 wt %, 5 wt %, 10 wt %, 15 wt %, 20 wt %, 25 wt %, or 30 wt %), based on the total weight of the second inorganic material. According to embodiments of the disclosure, in the second inorganic material, the weight ratio of the oxide solid electrolyte to the non-oxide solid electrolyte may be 65:35 to 99:1.

According to another embodiment of the disclosure, the second inorganic material may consist of the oxide solid electrolyte. According to another embodiment of the disclosure, the second inorganic material may consist of the oxide solid electrolyte and sulfide solid electrolyte. According to another embodiment of the disclosure, the second inorganic material may consist of the oxide solid electrolyte and halide solid electrolyte. According to another embodiment of the disclosure, the second inorganic material may consist of the oxide solid electrolyte, halide solid electrolyte and sulfide solid electrolyte.

According to embodiments of the disclosure, in the first inorganic material and the second inorganic material, when the amount of the oxide solid electrolyte is too low, the solid electrolyte film is apt to react with the positive electrode or negative electrode during the battery charging and discharging process, leading to a decrease in interface stability. This ultimately deteriorates the charging/discharging performance, safety in use, and cycle life of the battery. According to embodiments of the disclosure, the components of the first inorganic material and the components of the second inorganic material may be the same or different. The amount of the first inorganic material and the amount of the second inorganic material may be the same or different.

According to embodiments of the disclosure, the third inorganic material may include sulfide solid electrolyte. In addition, the third inorganic material may further include oxide solid electrolyte, halide solid electrolyte or a combination thereof. Herein, the amount of the sulfide solid electrolyte may be 51 wt % to 99 wt % (such as 55 wt %, 60 wt %, 65 wt %, 70 wt %, 75 wt %, 80 wt %, 85 wt %, 90 wt %, or 95 wt %); the amount of the components of the third inorganic material non-sulfide solid electrolyte (such as oxide solid electrolyte, halide solid electrolyte or a combination thereof) may be 1 wt % to 49 wt % (such as 2 wt %, 3 wt %, 5 wt %, 10 wt %, 15 wt %, 20 wt %, 25 wt %, 30 wt %, 35 wt %, 40 wt %, or 45 wt %), based on the total weight of the third inorganic material. According to embodiments of the disclosure, in the third inorganic material, the weight ratio of the sulfide solid electrolyte to the non-sulfide solid electrolyte may be 51:49 to 99:1.

According to another embodiment of the disclosure, the third inorganic material may consist of the sulfide solid electrolyte. According to another embodiment of the disclosure, the third inorganic material may consist of the sulfide solid electrolyte and oxide solid electrolyte. According to another embodiment of the disclosure, the third inorganic material may consist of the sulfide solid electrolyte and halide solid electrolyte. According to another embodiment of the disclosure, the third inorganic material may consist of the sulfide solid electrolyte, halide solid electrolyte, and oxide solid electrolyte.

According to embodiments of the disclosure, in the third inorganic material, when the amount of the sulfide solid electrolyte is too low, the solid electrolyte film exhibits lower ionic conductivity. Therefore, the resistance of the battery during charging and discharging is increased, thereby deteriorating the charging/discharging performance of the battery.

According to embodiments of the disclosure, the oxide solid electrolyte of the disclosure may be lithium-containing oxide solid electrolyte. According to embodiments of the disclosure, the oxide solid electrolyte of the disclosure does not contain sulfur. According to embodiments of the disclosure, the oxide solid electrolyte may include lithium-zirconium-containing oxide solid electrolyte, lithium-titanium-containing oxide solid electrolyte, lithium-iron-containing oxide solid electrolyte, lithium-aluminum-containing oxide solid electrolyte, lithium-germanium-containing oxide solid electrolyte, lithium-gallium-containing oxide solid electrolyte, lithium-lanthanum-containing oxide solid electrolyte, lithium-silicon-containing oxide solid electrolyte, lithium-phosphorus-containing oxide solid electrolyte, lithium-nitrogen-containing oxide solid electrolyte or a combination thereof. For example, the oxide solid electrolyte of the disclosure may be lithium lanthanum zirconate oxide (LLZO), lithium lanthanum titanate oxide (LLTO), lithium lanthanum zirconium tantalum oxide (LLZTO), lithium aluminum germanium phosphate (LAGP), lithium aluminum titanium phosphate (LATP) or a combination thereof.

According to embodiments of the disclosure, the sulfide solid electrolyte of the disclosure may include lithium-containing sulfide solid electrolyte. According to embodiments of the disclosure, the sulfide solid electrolyte of the disclosure may contain oxygen and/or halogen. According to embodiments of the disclosure, the sulfide solid electrolyte may include lithium-phosphorus-containing sulfide solid electrolyte, lithium-chlorine-containing sulfide solid electrolyte, lithium- bromine-containing sulfide solid electrolyte, lithium-fluorine-containing sulfide solid electrolyte, lithium-boron-containing sulfide solid electrolyte, lithium-silicon-containing sulfide solid electrolyte, lithium-germanium-containing sulfide solid electrolyte, lithium-gallium-containing sulfide solid electrolyte, lithium-zinc-containing sulfide solid electrolyte, lithium-indium-containing sulfide solid electrolyte, lithium-aluminum-containing sulfide solid electrolyte, lithium-tin-containing sulfide solid electrolyte or a combination thereof. For example, the sulfide solid electrolyte of the disclosure may include lithium phosphorus sulfide (LPS), lithium germanium phosphorus sulfide (LGPS), lithium tin phosphorus sulfide (LSPS), lithium phosphorus sulfur chloride (LPSC), lithium phosphorus sulfur bromide (LPSBr), lithium silicon phosphorus sulfur chloride (LSPSC) or a combination thereof.

According to embodiments of the disclosure, the halide solid electrolyte of the disclosure may include lithium-containing halide solid electrolyte. According to embodiments of the disclosure, the halide solid electrolyte of the disclosure does not include oxygen and/or sulfur. According to embodiments of the disclosure, the halide solid electrolyte may be lithium-indium-containing halide solid electrolyte, lithium-scandium-containing halide solid electrolyte, lithium-yttrium-containing halide solid electrolyte, lithium-lanthanide-containing halide solid electrolyte or a combination thereof. For example, the halide solid electrolyte of the disclosure may be lithium indium chloride, lithium indium bromide, lithium indium iodide, lithium yttrium chloride, lithium yttrium bromide, lithium yttrium iodide or a combination thereof.

According to embodiments of the disclosure, the first fluorine-containing polymer, the second fluorine-containing polymer and the third fluorine-containing polymer can individually include polytetrafluoroethylene (PTFE), polyvinylidene fluoride (PVDF), perfluoroalkoxy alkane (PFA), fluorinated ethylene propylene (FEP), polyvinylidene fluoride-co-hexafluoropropen (PVDF-HFP), or a combination thereof. According to embodiments of the disclosure, due to the hydrophobic properties of the fluorine-containing polymer, the performance of the battery would not be reduced. According to embodiments of the disclosure, the weight average molecular weight (Mw) of the first fluorine-containing polymer, the second fluorine-containing polymer, and the third fluorine-containing polymer are not limited and may be about 800 g/mol to 5,000,000 g/mol, such as 1,000 g/mol, 2,000 g/mol, 3,000 g/mol, 5,000 g/mol, 8,000 g/mol, 10,000 g/mol, 15,000 g/mol, 20,000 g/mol, 30,000 g/mol, 50,000 g/mol, 80,000 g/mol, 100,000 g/mol, 200,000 g/mol, 500,000 g/mol, 800,000 g/mol, 1,000,000 g/mol, 2,000,000 g/mol, 3,000,000 g/mol, 4,000,000 g/mol, or 4,500,000 g/mol. The weight average molecular weight (Mw) of the fluorine-containing polymer of the disclosure can be determined by gel permeation chromatography (GPC) (based on a polystyrene calibration curve).

According to embodiments of the disclosure, the method for preparing the solid electrolyte film of the disclosure preparation may include following steps. The first inorganic material and the first fluorine-containing polymer are mixed, and the mixture is ground and the results are subjected to a rolling process, obtaining the first protective layer. The second inorganic material and the second fluorine-containing polymer are mixed, and the mixture is ground and the results are subjected to a rolling process, obtaining the second protective layer. The third inorganic material and the third fluorine-containing polymer are mixed, and the mixture is ground and the results are subjected to a rolling process, obtaining the electrolyte layer. Next, the electrolyte layer and the second protective layer are subsequently disposed on the first protective layer, obtaining a lamination (i.e. a lamination of the first protective layer/the electrolyte layer/the second protective layer). Next, the lamination is subjected to a compression process, obtaining the solid electrolyte film of the disclosure.

According to embodiments of the disclosure, the battery of the disclosure may include a positive electrode, a negative electrode, and the solid electrolyte film of the disclosure. The solid electrolyte film may be disposed between the positive electrode and the negative electrode. According to embodiments of the disclosure, the solid electrolyte film may include the first protective layer, the electrolyte layer, and the second protective layer.

FIG. 2 is a schematic view of the battery according to embodiments of the disclosure. As shown in FIG. 2, the battery 100 includes a negative electrode 20, a positive electrode 30, and a solid electrolyte film 10. The negative electrode 20 is separated from the positive electrode 30 via the solid electrolyte film 10. In the battery 100, the first protective layer 12 of the solid electrolyte film 10 may be disposed between the electrolyte layer 14 and the positive electrode 30 in order to separate the electrolyte layer 14 from the positive electrode 30. The second protective layer 16 of the solid electrolyte film 10 may be disposed between the electrolyte layer 14 and the negative electrode 20, in order to separate the electrolyte layer 14 from the negative electrode 20. Namely, by means of the specific structural design of the solid electrolyte film 10 (i.e. the electrolyte layer 14 is disposed between the first protective layer 12 and second protective layer 16), a direct contact between the electrolyte layer 14 and the negative electrode 20 as well as the positive electrode 30 can be prevented, thereby improving the lithium-ion transmission capabilities and stability of the solid electrolyte film 10.

According to embodiments of the disclosure, the negative electrode 20 may include a negative electrode active layer (not shown). According to embodiments of the disclosure, the negative electrode active layer may include a negative electrode active material, wherein the negative electrode active material may be carbon material, lithium, transition metal oxide, lithium-containing compound, silicon-containing material, tin, tin-containing compound or a combination thereof. According to embodiments of the disclosure, the carbon material may include metastable phase spherical carbon (MCMB), vapor grown carbon fiber (VGCF), carbon nanotube (CNT), coke, carbon black, graphite, graphene, acetylene black, carbon fiber, metastable phase spherical carbon (MCMB), glassy carbon or a combination thereof. According to embodiments of the disclosure, the lithium-containing compound may include LiAl, LiMg, LiZn, Li₃Bi, Li₃Cd, Li₃Sb, Li₄Si, Li_{4.4}Pb, Li_{4.4}Sn, LiC₆, Li₃FeN₂, Li_{2.6}Co_{0.4}N, or Li_{2.6}Cu_{0.4}N. According to embodiments of the disclosure, the silicon-containing material may include carbon-modified silicon oxide, silicon carbide or pure-silicon material. According to embodiments of the disclosure, the transition metal oxide may include Li₄Ti₅O₁₂, or TiNb₂O₇.

According to embodiments of the disclosure, the negative electrode active layer may further include a conductive additive. According to embodiments of the disclosure, the conductive additive may be conductive carbon black, conductive graphite, fluorocarbon, reduced graphene, nitrogen-doped graphite, nitrogen-doped graphene, carbon fiber, carbon nanotube or a combination thereof.

The negative electrode active layer may further include a binder. The binder may include polyvinyl alcohol (PVA), polytetrafluoroethylene (PTFE), polyvinylidene fluoride (PVDF), poly(styrene-co-butadiene), fluorine rubber, polyurethane, polyvinylpyrrolidone, polyvinyl carbonate, polyvinyl chloride (PVC), polyacrylonitrile (PAN), polybutadiene, poly(acrylic acid) (PAA), perfluoroalkoxy alkane (PFA), fluorinated ethylene propylene (FEP), polyvinylidene fluoride-co-hexafluoropropen (PVDF-HFP), styrene-butadiene rubber (SBR), acrylic resin, polyethylene glycol (PEG), poly(ethylene oxide (PEO), carboxymethyl cellulose (CMC) or a combination thereof.

According to another embodiment of the disclosure, the negative electrode active layer may consist of a negative electrode active material and a binder. According to another embodiment of the disclosure, the negative electrode active layer may consist of a negative electrode active material, a conductive additive, and a binder.

According to embodiments of the disclosure, in the negative electrode active layer, the weight ratio of the binder to the negative electrode active material may be about 1:99 to 20:80 (such as 2:98, 3:97, 5:95, 10:90, or 15:85). According to embodiments of the disclosure, in the negative electrode active layer, the weight ratio of the conductive additive to the negative electrode active material may be about 1:99 to 20:80 (such as 2:98, 3:97, 5:95, 10:90, or 15:85).

According to embodiments of the disclosure, the thickness of the negative electrode active layer is not limited and can be optionally modified by a person of ordinary skill in the field. For example, the thickness of the negative electrode active layer may be about 1 μm to 1,000 μm (such as about 5 μm, 10 μm, 50 μm, 100 μm, 200 μm, 300 μm, 400 μm, 500 μm, 600 μm, 700 μm, 800 μm, or 900 μm).

According to embodiments of the disclosure, the negative electrode 20 may further includes a negative electrode current-collecting layer (not shown), wherein the negative electrode active layer is disposed on the negative electrode current-collecting layer. According to embodiments of the disclosure, the thickness of the negative electrode current-collecting layer is not limited and can be optionally modified by a person of ordinary skill in the field. For example, the thickness of the negative electrode current-collecting layer may be about 100 μm to 5,000 μm (such as about 200 μm, 300 μm, 400 μm, 500 μm, 600 μm, 700 μm, 800 μm,900 μm, 1,000 μm, 2,000 μm, 3,000 μm, or 4,000 μm). According to embodiments of the disclosure, the negative electrode current-collecting layer may be conductive carbon substrate, metal foil, or metal material with a porous structure, such as carbon cloth, carbon felt, or carbon paper, copper foil, nickel foil, aluminum foil, nickel net, copper net, molybdenum net, nickel foam, copper foam, or molybdenum foam. According to embodiments of the disclosure, the metal material with a porous structure may have a porosity about 10% to 99.9% (such as: 20%, 30%, 40%, 50%, 60%, 70%, 80%, or 90%). According to another embodiment of the disclosure, the negative electrode 20 may consist of a negative electrode active layer. According to another embodiment of the disclosure, the negative electrode 20 may consist of the negative electrode active layer and the negative electrode current-collecting layer.

According to embodiments of the disclosure, the positive electrode 30 may include a positive electrode active layer (not shown). According to embodiments of the disclosure, the positive electrode active layer may include a positive electrode active material, wherein positive electrode active material may be sulfur, organic sulfide, sulfur-carbon composite, metal-containing lithium oxide, metal-containing lithium sulfide, metal-containing lithium selenide, metal-containing lithium telluride, metal-containing lithium phosphide, metal-containing lithium silicide, metal-containing lithium boride, or a combination thereof, wherein the metal is selected from a group consisting of aluminum, vanadium, titanium, chromium, copper, molybdenum, niobium, iron, nickel, cobalt and manganese. According to embodiments of the disclosure, the positive electrode active material may be lithium-cobalt oxide, lithium-nickel oxide, lithium-manganese oxide, lithium-cobalt-manganese oxide, lithium-nickel-cobalt oxide, lithium-nickel-manganese oxide, lithium-nickel-manganese-cobalt oxide, lithium-chromium-manganese oxide, lithium-nickel-vanadium oxide, lithium-manganese-nickel oxide, lithium-cobalt-vanadium oxide, lithium-nickel-cobalt-aluminum oxide, lithium-iron phosphate, or a combination thereof.

According to embodiments of the disclosure, the lithium-nickel-manganese-cobalt oxide of the disclosure may have a structure of LiNiₓCo_{y}Mn_{z}O₂, wherein 0<x<1, 0<y<1, 0<z<1, and x+y+z=1. According to embodiments of the disclosure, lithium nickel cobalt aluminum oxide may have a chemical structure of LiNi_{0.80}Co_{0.15}Al_{0.05}O₂. According to embodiments of the disclosure, lithium cobalt oxide may have a chemical structure of LiCoO₂.

According to embodiments of the disclosure, the positive electrode active layer may further include a conductive additive. According to embodiments of the disclosure, the conductive additive may be conductive carbon black, conductive graphite, fluorocarbon, reduced graphene, nitrogen-doped graphite, nitrogen-doped graphene, carbon fiber, carbon nanotube, or a combination thereof.

The positive electrode active layer may further include a binder. The binder may include polyvinyl alcohol (PVA), polytetrafluoroethylene (PTFE), polyvinylidene fluoride (PVDF), poly(styrene-co-butadiene), fluorine rubber, polyurethane, polyvinylpyrrolidone, polyvinyl carbonate, polyvinyl chloride (PVC), polyacrylonitrile (PAN), polybutadiene, poly(acrylic acid) (PAA), perfluoroalkoxy alkane (PFA), fluorinated ethylene propylene (FEP), polyvinylidene fluoride-co-hexafluoropropen (PVDF-HFP), styrene-butadiene rubber (SBR), acrylic resin, polyethylene glycol (PEG), poly(ethylene oxide (PEO), carboxymethyl cellulose (CMC), or a combination thereof.

According to another embodiment of the disclosure, the positive electrode active layer may consist of a positive electrode active material and a binder. According to another embodiment of the disclosure, the positive electrode active layer may consist of a positive electrode active material, a conductive additive and a binder.

According to embodiments of the disclosure, in the positive electrode active layer, the weight ratio of the binder to the positive electrode active material may be about 1:99 to 20:80 (such as 2:98, 3:97, 5:95, 10:90, or 15:85). According to embodiments of the disclosure, in the positive electrode active layer, the weight ratio of the conductive additive to the positive electrode active material may be about 1:99 to 20:80 (such as 2:98, 3:97, 5:95, 10:90, or 15:85).

According to embodiments of the disclosure, the thickness of the positive electrode active layer is not limited and can be optionally modified by a person of ordinary skill in the field. For example, the thickness of the positive electrode active layer may be about 1 μm to 1,000 μm (such as about 5 μm, 10 μm, 50 μm, 100 μm, 200 μm, 300 μm, 400 μm, 500 μm,600 μm,700 μm,800 μm, or 900 μm).

According to embodiments of the disclosure, the positive electrode 30 may further includes a positive electrode current-collecting layer (not shown), wherein the positive electrode active layer is disposed on the positive electrode current-collecting layer. According to embodiments of the disclosure, the thickness of the positive electrode current-collecting layer is not limited and can be optionally modified by a person of ordinary skill in the field. For example, the thickness of the positive electrode current-collecting layer may be about 100 μm to 5,000 μm (such as about 200 μm, 300 μm, 400 μm, 500 μm,600 μm,700 μm, 800 μm,900 μm, 1,000 μm, 2,000 μm, 3,000 μm, or 4,000 μm). According to embodiments of the disclosure, the positive electrode current-collecting layer may be conductive carbon substrate, metal foil, or metal material with a porous structure, such as carbon cloth, carbon felt, or carbon paper, copper foil, nickel foil, aluminum foil, nickel net, copper net, molybdenum net, nickel foam, copper foam, or molybdenum foam. According to embodiments of the disclosure, the metal material with a porous structure may have a porosity about 10% to 99.9% (such as: 20%, 30%, 40%, 50%, 60%, 70%, 80%, or 90%). According to another embodiment of the disclosure, the positive electrode 30 may consist of positive electrode active layer. According to another embodiment of the disclosure, the positive electrode 30 may consist of the positive electrode active layer and the positive electrode current-collecting layer.

According to embodiments of the disclosure, the solid electrolyte film 10 serves as an electrolyte and can isolate the positive electrode 30 from the negative electrode 20. Therefore, the battery of the disclosure may not include a separator commonly used in conventional batteries using liquid electrolyte. In addition, according to embodiments of the disclosure, the battery of the disclosure may not include a liquid electrolyte.

According to another embodiment of the disclosure, the battery of the disclosure may further include a separator disposed between the positive electrode and the negative electrode for improving the mechanical strength of the solid electrolyte film.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLE

### Preparation of Solid Electrolyte Film

### Example 1

99 parts by weight of lithium lanthanum zirconate oxide (LLZO) and 1 part by weight of polytetrafluoroethylene (PTFE) were mixed. The mixture was ground and the results were subjected to a rolling process, obtaining a protective layer (with a thickness of about 100 μm and a diameter of about 1.2 cm) after cutting. 99 parts by weight of lithium phosphorus sulfur chloride (LPSC) and 1 part by weight of polytetrafluoroethylene (PTFE) were mixed. The mixture was ground and the results were subjected to a rolling process, obtaining an electrolyte layer (with a thickness of about 100 μm and a diameter of about 1.2 cm) after cutting. Next, the electrolyte layer was disposed between two protective layers, to form a lamination of protective layer/electrolyte layer/protective layer. Next, the lamination was subjected to a compression process (with a pressure of 10 MPa), obtaining Solid electrolyte film (1) (with a thickness of about 470 μm). The thickness was measured by a thickness gauge.

### Comparative Example 1

99 parts by weight of lithium phosphorus sulfur chloride (LPSC) and 1 part by weight of polytetrafluoroethylene (PTFE) were mixed. The mixture was ground and the results were subjected to a rolling process, obtaining an electrolyte layer (with a thickness of about 100 μm and a diameter of about 1.2 cm) after cutting. Next, the electrolyte layer was subjected to a compression process (with a pressure of 10 MPa), obtaining Solid electrolyte film (2).

### Example 2

99 parts by weight of lithium lanthanum zirconate oxide (LLZO) and 1 part by weight of polytetrafluoroethylene (PTFE) were mixed. The mixture was ground and the results were subjected to a rolling process, obtaining a protective layer (with a thickness of about 100 μm and a diameter of about 1.2 cm) after cutting. 99 parts by weight of lithium phosphorus sulfur bromide (LPSBr) and 1 part by weight of polytetrafluoroethylene (PTFE) were mixed. The mixture was ground and the results were subjected to a rolling process, obtaining an electrolyte layer (with a thickness of about 100 μm and a diameter of about 1.2 cm) after cutting. Next, the electrolyte layer was disposed between two protective layers, to form a lamination of protective layer/electrolyte layer/protective layer. Next, the lamination was subjected to a compression process (with a pressure of 10 MPa), obtaining Solid electrolyte film (3) (with a thickness of about 460 μm).

### Comparative Example 2

99 parts by weight of lithium phosphorus sulfur bromide (LPSBr) and 1 part by weight of polytetrafluoroethylene (PTFE) were mixed. The mixture was ground and the results were subjected to a rolling process, obtaining an electrolyte layer (with a thickness of about 100 μm and a diameter of about 1.2 cm) after cutting. Next, the electrolyte layer was subjected to a compression process (with a pressure of 10 MPa), obtaining Solid electrolyte film (4).

### Example 3

99 parts by weight of lithium lanthanum zirconate oxide (LLZO) and 1 part by weight of polytetrafluoroethylene (PTFE) were mixed. The mixture was ground and the results were subjected to a rolling process, obtaining a protective layer (with a thickness of about 100 μm) after cutting. 99 parts by weight of lithium germanium phosphorus sulfide (LGPS) and 1 part by weight of polytetrafluoroethylene (PTFE) were mixed. The mixture was ground and the results were subjected to a rolling process, obtaining an electrolyte layer (with a thickness of about 300 μm) after cutting. Next, the electrolyte layer was disposed between two protective layers, to form a lamination of protective layer/electrolyte layer/protective layer. Next, the lamination was subjected to a compression process (with a pressure of 10 MPa), obtaining Solid electrolyte film (5) (with a thickness of about 460 μm).

### Comparative Example 3

99 parts by weight of lithium germanium phosphorus sulfide (LGPS) and 1 part by weight of polytetrafluoroethylene (PTFE) were mixed. The mixture was ground and the results were subjected to a rolling process, obtaining an electrolyte layer (with a thickness of about 300 μm) after cutting. Next, the electrolyte layer was subjected to a compression process (with a pressure of 10 MPa), obtaining Solid electrolyte film (6).

### Example 4

89.1 part by weight of lithium lanthanum zirconate oxide (LLZO), 4.95 parts by weight of lithium aluminum titanium phosphate (LATP), 4.95 parts by weight of lithium indium chloride (LIC) and 1 part by weight of polytetrafluoroethylene (PTFE) were mixed. The mixture was ground and the results were subjected to a rolling process, obtaining a protective layer (with a thickness of about 100 μm) after cutting. 99 parts by weight of lithium phosphorus sulfur chloride (LPSC) and 1 part by weight of polytetrafluoroethylene (PTFE) were mixed. The mixture was ground and the results were subjected to a rolling process, obtaining an electrolyte layer (with a thickness of about 100 μm and a diameter of about 1.2 cm) after cutting. Next, the electrolyte layer was disposed between two protective layers, to form a lamination of protective layer/electrolyte layer/protective layer. Next, the lamination was subjected to a compression process (with a pressure of 10 MPa), obtaining Solid electrolyte film (7) (with a thickness of about 480 μm).

### Performance of Negative Electrode (Half Battery Evaluation)

### Example 5

Solid electrolyte film (1) of Example 1 and two lithium foils (commercially available from FMC Lithium Corp.) (with a thickness of 200 μm) (serving as the positive electrode and the negative electrode respectively) were provided.

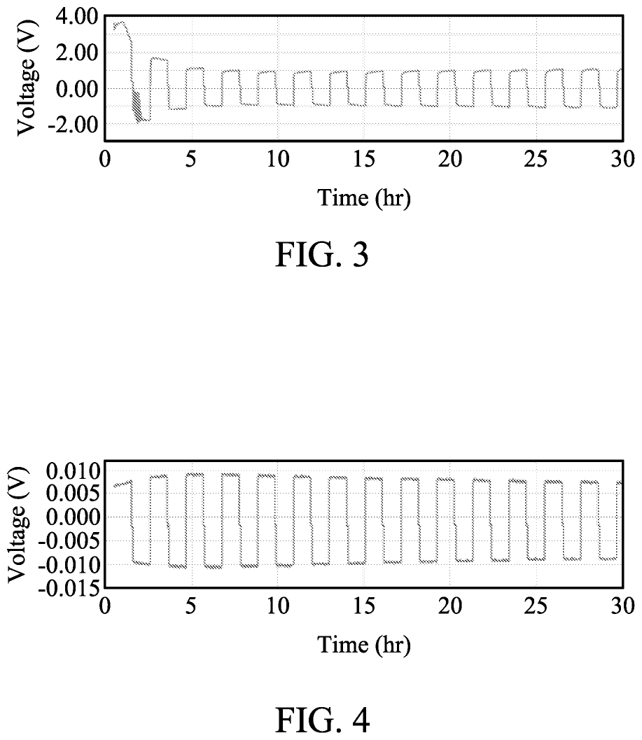

Next, the negative electrode, Solid electrolyte film (1) and the positive electrode were placed in sequence and sealed to obtain a coin cell battery. Next, the coin cell battery was subjected to a charging/discharging cycle test under a constant current of 0.1 mA at 55° C. for 1 hour (i.e. charging/discharging time for each cycle), and the results are shown in FIG. 3.

### Comparative Example 4

Comparative Example 4 was performed in the same manner as the method for preparing the coin cell battery of Example 5, except that Solid electrolyte film (1) was replaced with Solid electrolyte film (2) of Comparative Example 1, obtaining a coin cell battery. Next, the coin cell battery was subjected to the charging/discharging cycle test, and the results are shown in FIG. 4.

As shown in FIG. 4, the coin cell battery of Comparative Example 4 exhibited an initial charging/discharging voltage difference that had approached zero. It indicates that an irreversible short-circuit phenomenon had occurred during the initial charging/discharging cycle test of the coin cell battery. As shown in FIG. 3, the coin cell battery of Example 5 experienced an unstable potential during the initial charging/discharging cycle test due to the opening of ion channels. From the second cycle onwards, it exhibited a stable charging/discharging platform, and no short-circuit occurred.

### Example 6

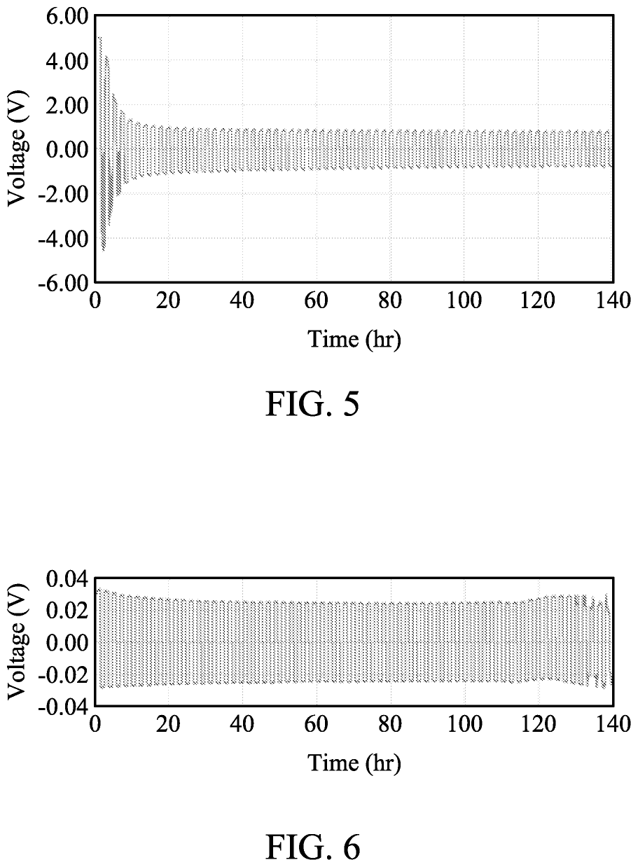

Example 6 was performed in the same manner as the method for preparing the coin cell battery of Example 5, except that Solid electrolyte film (1) was replaced with Solid electrolyte film (3) of Example 2, obtaining the coin cell battery. Next, the coin cell battery was subjected to the charging/discharging cycle test, and the results are shown in FIG. 5.

### Comparative Example 5

Comparative Example 5 was performed in the same manner as the method for preparing the coin cell battery of Example 5, except that Solid electrolyte film (1) was replaced with Solid electrolyte film (4) of Comparative Example 2, obtaining the coin cell battery. Next, the coin cell battery was subjected to the charging/discharging cycle test, and the results are shown in FIG. 6.

As shown in FIG. 6, the coin cell battery of Comparative Example 5 exhibited a less stable charging/discharging platform. It indicates that a reversible short-circuit phenomena (soft short circuits) was occurred. Furthermore, after 130 hours of charging/discharging cycle test, the voltage of coin cell battery of Comparative Example 5 significantly reduced, indicating the occurrence of irreversible short-circuit phenomena. As shown in FIG. 5, the coin cell battery of Example 6 exhibited an unstable voltage during the initial charging/discharging cycle test due to the opening of ion channels. From the second cycle onwards, it showed a stable charging/discharging platform. Even after 140 hours of charging/discharging cycle test, there was no short-circuit occurred.

### Example 7

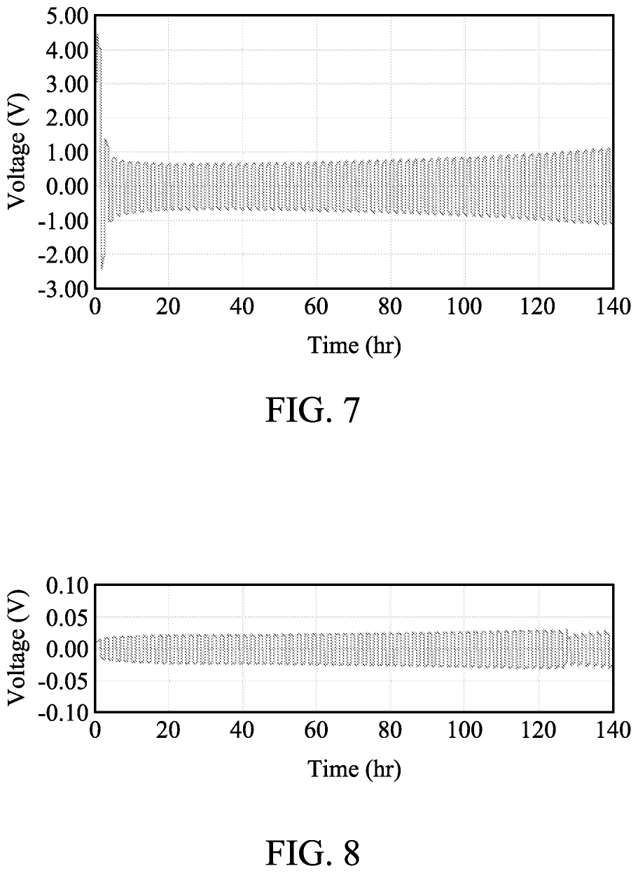

Example 7 was performed in the same manner as the method for preparing the coin cell battery of Example 5, except that Solid electrolyte film (1) was replaced with Solid electrolyte film (5) of Example 3, obtaining the coin cell battery. Next, the coin cell battery was subjected to the charging/discharging cycle test, and the results are shown in FIG. 7.

### Comparative Example 6

Comparative Example 6 was performed in the same manner as the method for preparing the coin cell battery of Example 5, except that Solid electrolyte film (1) was replaced with Solid electrolyte film (6) of Comparative Example 3, obtaining the coin cell battery. Next, the coin cell battery was subjected to the charging/discharging cycle test, and the results are shown in FIG. 8.

As shown in FIG. 8, the coin cell battery of Comparative Example 6 exhibited a less stable charging/discharging platform. It indicates that a reversible short-circuit phenomena (soft short circuits) was occurred. Furthermore, after 130 hours of charging/discharging cycle test, the voltage of coin cell battery of Comparative Example 6 significantly reduced, indicating the occurrence of irreversible short-circuit phenomena. As shown in FIG. 7, the coin cell battery of Example 7 exhibited an unstable voltage during the initial charging/discharging cycle test due to the opening of ion channels. From the second cycle onwards, it showed a stable charging/discharging platform. Even after 140 hours of charging/discharging cycle test, there was no short-circuit occurred.

### Example 8

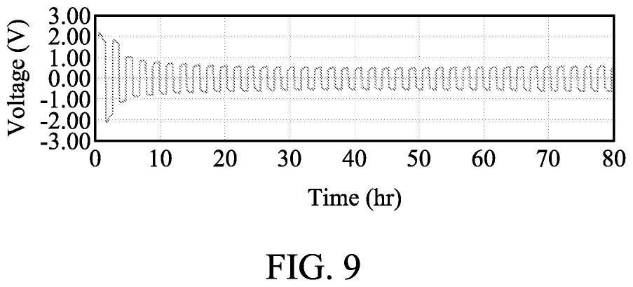

Example 8 was performed in the same manner as the method for preparing the coin cell battery of Example 5, except that Solid electrolyte film (1) was replaced with Solid electrolyte film (7) of Example 4, obtaining the coin cell battery. Next, the coin cell battery was subjected to the charging/discharging cycle test, and the results are shown in FIG. 9.

As shown in FIGS. 3, 5, 7, and 9, the batteries of the disclosure exhibited a stable charge-discharge platform after the second cycle. It indicates that during the charging and discharging process, a stable solid electrolyte interface (SEI) was formed within the coin cell battery of the disclosure.

Accordingly, due to the specific structural design and the specific components of layers, the solid electrolyte film of the disclosure exhibits flexibility, high ionic conductivity, and improved mechanical strength. As a result, the stability, charging/discharging performance, and safety of batteries employing the solid electrolyte film of the disclosure may be enhanced, thereby extending the cycle life of the batteries.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A solid electrolyte film, comprising:
a first protective layer, wherein the first protective layer comprises a first inorganic material;
a second protective layer, wherein the second protective layer comprises a second inorganic material, and wherein each of the first inorganic material and the second inorganic material comprises an oxide solid electrolyte; and
an electrolyte layer disposed between the first protective layer and the second protective layer, wherein the electrolyte layer comprises a third inorganic material, wherein the third inorganic material comprises sulfide solid electrolyte.

2. The solid electrolyte film as claimed in claim 1, wherein the oxide solid electrolyte comprises lithium-zirconium-containing oxide solid electrolyte, lithium-titanium-containing oxide solid electrolyte, lithium-iron-containing oxide solid electrolyte, lithium-aluminum-containing oxide solid electrolyte, lithium-germanium-containing oxide solid electrolyte, lithium-gallium-containing oxide solid electrolyte, lithium-lanthanum-containing oxide solid electrolyte, lithium-silicon-containing oxide solid electrolyte, lithium-phosphorus-containing oxide solid electrolyte, lithium-nitrogen-containing oxide solid electrolyte, or a combination thereof.

3. The solid electrolyte film as claimed in claim 1, wherein the sulfide solid electrolyte comprises lithium-phosphorus-containing sulfide solid electrolyte, lithium-chlorine-containing sulfide solid electrolyte, lithium-bromine-containing sulfide solid electrolyte, lithium-fluorine-containing sulfide solid electrolyte, lithium-boron-containing sulfide solid electrolyte, lithium-silicon-containing sulfide solid electrolyte, lithium-germanium-containing sulfide solid electrolyte, lithium-gallium-containing sulfide solid electrolyte, lithium-zinc-containing sulfide solid electrolyte, lithium-indium-containing sulfide solid electrolyte, lithium-aluminum-containing sulfide solid electrolyte, lithium-tin-containing sulfide solid electrolyte, or a combination thereof.

4. The solid electrolyte film as claimed in claim 1, wherein a thickness of the first protective layer and a thickness of the second protective layer are independently from 30 μm to 200 μm.

5. The solid electrolyte film as claimed in claim 1, wherein a thickness of the electrolyte layer is from 30 μm to 700 μm.

6. The solid electrolyte film as claimed in claim 1, wherein a total thickness of the first protective layer, the second protective layer and the electrolyte layer is from 200 μm to 1,100 μm.

7. The solid electrolyte film as claimed in claim 1, wherein the first protective layer further comprises a first fluorine-containing polymer, the second protective layer further comprises a second fluorine-containing polymer, and the electrolyte layer further comprises a third fluorine-containing polymer.

8. The solid electrolyte film as claimed in claim 7, wherein a weight ratio of the first fluorine-containing polymer to the first inorganic material is from 0.1:99.9 to 5:95, a weight ratio of the second fluorine-containing polymer to the second inorganic material is from 0.1:99.9 to 5:95, and a weight ratio of the third fluorine-containing polymer to the third inorganic material is from 0.1:99.9 to 5:95.

9. The solid electrolyte film as claimed in claim 7, wherein each of the first fluorine-containing polymer, the second fluorine-containing polymer and the third fluorine-containing polymer independently comprises polytetrafluoroethylene (PTFE), polyvinylidene fluoride (PVDF), perfluoroalkoxy alkane (PFA), fluorinated ethylene propylene (FEP), polyvinylidene fluoride-co-hexafluoropropen (PVDF-HFP), or a combination thereof.

10. The solid electrolyte film as claimed in claim 1, wherein the first inorganic material further comprises sulfide solid electrolyte, halide solid electrolyte or a combination thereof, and a weight percentage of the oxide solid electrolyte of the first inorganic material is from 65 wt % to 99 wt %, based on the total weight of the first inorganic material; and, the second inorganic material further comprises sulfide solid electrolyte, halide solid electrolyte or a combination thereof, and a weight percentage of the oxide solid electrolyte of the second inorganic material is from 65 wt % to 99 wt %, based on the total weight of the second inorganic material.

11. The solid electrolyte film as claimed in claim 1, wherein the third inorganic material further comprises oxide solid electrolyte, halide solid electrolyte or a combination thereof, and a weight percentage of the sulfide solid electrolyte of the third inorganic material is from 51 wt % to 99 wt %, based on the total weight of the third inorganic material.

12. A battery, comprising:
a negative electrode;
a solid electrolyte film, wherein the solid electrolyte film is the solid electrolyte film as claimed in claim 1; and
a positive electrode, wherein the solid electrolyte film is disposed between the positive electrode and the negative electrode.

13. The battery as claimed in claim 12, wherein the negative electrode comprises a negative electrode active material, and the negative electrode active material comprises carbon material, lithium, transition metal oxide, lithium-containing compound, silicon-containing material, tin, tin-containing compound, or a combination thereof.

14. The battery as claimed in claim 12, wherein the positive electrode comprises a positive electrode active material, and the positive electrode active material comprises sulfur, organic sulfide, sulfur-carbon composite, metal-containing lithium oxide, metal-containing lithium sulfide, metal-containing lithium selenide, metal-containing lithium telluride, metal-containing lithium phosphide, metal-containing lithium silicide, metal-containing lithium boride, or a combination thereof, wherein the metal is selected from a group consisting of aluminum, vanadium, titanium, chromium, copper, molybdenum, niobium, iron, nickel, cobalt, and manganese.
